(19) United States
(12) Patent Application Publication
(10) Pub. No.: US 2009/0129379 A1
(43) Pub. Date: May 21, 2009

(54) RECONSTRUCTING DATA ON A NETWORK

(75) Inventors: RICHARD COSIMO DIBIASO, Methuen, MA (US); SEAN STANLEY BRUMBLE, Mansfield, MA (US); JAY MICHAEL ERICKSON, Wellesley, MA (US); MICHAEL L. WEST, Stratham, NH (US); WILLIAM KENT Van VLIET, Brighton, MA (US); MARC THOMAS LEAVITT, Hopkinton, NH (US)

Correspondence Address: PROSKAUER ROSE LLP, ONE INTERNATIONAL PLACE, BOSTON, MA, 02110, US

(73) Assignee: FMR LLC, Boston, MA (US)

(21) Appl. No.: 11/943,899

(22) Filed: Nov. 21, 2007

(51) Int. Cl. H04L 12/56

(52) U.S. Cl. 370/389

(57) ABSTRACT

Described are computer-based methods and apparatuses, including computer program products, for parsing, flagging, and/or reconstructing data on a network. Data packets associated with user requests are distributed among a plurality of data centers for processing. The data packets are captured at the data centers for fraud detection. The captured data packets are preprocessed at the data center. The preprocessing includes disregarding data packets that are not applicable to fraud detection. The preprocessing includes indicating if data packets are applicable to fraud detection. The indicating of the applicable data packets includes parsing the data packets using particular rules optimized for fraud detection. The data packets are processed at each data center to reconstruct part of the data associated with a user. The processing of the data packets includes reconstructing the data packets based on customer information from network information and/or cookie information. The reconstructed data packets are transmitted to a central processing center (e.g., central data center). The central processing center receives reconstructed data packets from the plurality of data centers and unifies the reconstructed data packets into data associated with a user.

### CROSS REFERENCE TO RELATED APPLICATIONS

This application is related to co-pending U.S. patent application Ser. No. TBD Attorney Docket No. FID-028A, filed Nov. 21, 2007, and entitled “Parsing and Flagging Data on a Network” which is commonly assigned to the same entity.

### FIELD OF THE INVENTION

The present invention relates generally to computer-based methods and apparatuses, including computer program products, for parsing, flagging, and/or reconstructing data on a network.

### BACKGROUND

The increased use of networks to access and provide information has caused a dramatic increase in the amount of data transmitted over networks. To handle this increased amount of traffic, computer systems used to store, process, and transmit the information have been increasing in size and distributed among data centers. This distribution among data centers allows for increased speed which allows for decreased response time in the retrieval and processing of information.

However, the increased speed and diversified data centers create an issue with the data that is sent to a plurality of data centers. The issue is that the data sent to and from users is distributed among the data centers. When the data from only one data center is analyzed, then it is extremely challenging if not impossible to obtain a complete representation of a user's activity.

The ability to analyze a user's activity as a whole is important in a wide spectrum of industries that provide trusted services over a network. These industries have to be able to analyze user activity to provide feedback and improve performance of the systems. In addition, industries have to be able to effectively and efficiently identify fraudulent activity on their networks.

Fraudulent activity has been increasing along with the rise in network based activity. Industries have responded by utilizing fraud detection systems to attempt to stop the loss of money and prestige. However, it has been challenging if not impossible for these fraud detection systems to collect the data from all of the data centers in real time and without impacting the customer's experience. Since fraudulent activity is increasing, it is important for industries, such as the financial services industry, to have a fraud detection system that can collect data packets from a plurality of data centers and reconstruct the data for the detection of fraudulent activity and other uses.

### SUMMARY OF THE INVENTION

One approach is filtering and adding an indicator to data on a network. In one aspect, there is a method. The method includes receiving a first set of data packets at a first data center selected from a plurality of data centers. The method further includes filtering the first set of data packets to form a second set of data packets, adding an indicator to one or more data packets in the second set of data packets, the indicator being utilized by a fraud detection system to indicate additional processing for the one or more data packets, and transmitting the second set of data packets to the fraud detection system.

In another aspect, there is a computer program product. The computer program product is tangibly embodied in a computing device or a removable storage device. The computer program product includes instructions being operable to cause a data processing apparatus to receive a first set of data packets at a first data center selected from a plurality of data centers. The first set of data packets is filtered to form a second set of data packets. An indicator is added to one or more data packets in the second set of data packets. The indicator being utilized by a fraud detection system to indicate additional processing for the one or more data packets. The second set of data packets is transmitted to the fraud detection system.

In another aspect, there is a system for filtering and adding an indicator to data on a network. The system includes a first data center. The first data center is selected from a plurality of data centers. The first data center is configured to receive a first set of data packets, filter the first set of data packets to form a second set of data packets, add an indicator to one or more data packets in the second set of data packets, the indicator being utilized by a fraud detection system to indicate additional processing for the one or more data packets, and transmit the second set of data packets to the fraud detection system.

In another aspect, there is a system for filtering and adding an indicator to data on a network. The system includes a means for receiving a first set of data packets at a first data center, selected from a plurality of data centers. The system further includes a means for filtering the first set of data packets to form a second set of data packets. The system further includes a means for adding an indicator to one or more data packets in the second set of data packets. The indicator being utilized by a fraud detection system to indicate additional processing for the one or more data packets. The system further includes a means for transmitting the second set of data packets to the fraud detection system.

Another approach is preprocessing and reconstructing data on a network. In one aspect, there is a method. The method includes receiving a first set of data packets at a first data center selected from a plurality of data centers. The method further includes searching the first data center for a second set of data packets related to the first set of data packets, reconstructing a third set of data packets from the first set of data packets and the second set of data packets, the third set of data packets being transmitted from a user location, and receiving a fourth set of data packets at a second data center selected from a plurality of data centers, the second data center being different from the first data center. The method further includes searching the second data center for a fifth set of data packets related to the fourth set of data packets and reconstructing a sixth set of data packets from the fourth set of data packets and the fifth set of data packets, the sixth set of data packets being transmitted from the user location.

In another aspect, there is a computer program product. The computer program product is tangibly embodied in a computing device or a removable storage device. The computer program product includes instructions being operable to cause a data processing apparatus to receive a first set of data packets at a first data center selected from a plurality of data centers, search the first data center for a second set of data packets related to the first set of data packets, reconstruct a third set of data packets from the first set of data packets and the second set of data packets, the third set of data packets being transmitted from a user location, receive a fourth set of data packets at a second data center selected from a plurality of data centers, the second data center being different from the first data center, search the second data center for a fifth set of data packets related to the fourth set of data packets, and reconstruct a sixth set of data packets from the fourth set of data packets and the fifth set of data packets, the sixth set of data packets being transmitted from the user location.

In another aspect, there is a system for preprocessing and reconstructing data on a network. The system includes a first data center and a second data center. The first data center is selected from a plurality of data centers. The first data center is configured to receive a first set of data packets, search the first data center for a second set of data packets related to the first set of data packets, and reconstruct a third set of data packets from the first set of data packets and the second set of data packets, and the third set of data packets being transmitted from a user location. The second data center is selected from a plurality of data centers and different from the first data center. The second data center is configured to receive a fourth set of data packets, search the second data center for a fifth set of data packets related to the fourth set of data packets, and reconstruct a sixth set of data packets from the fourth set of data packets and the fifth set of data packets, the sixth set of data packets being transmitted from the user location.

In another aspect, there is a system for preprocessing and reconstructing data on a network. The system includes a means for receiving a first set of data packets at a first data center, selected from a plurality of data centers, a means for searching the first data center for a second set of data packets related to the first set of data packets, a means for reconstructing a third set of data packets from the first set of data packets and the second set of data packets, the third set of data packets being transmitted from a user location. The system further includes a means for receiving a fourth set of data packets at a second date center, selected from a plurality of data centers and different from the first data center, a means for searching the second data center for a fifth set of data packets related to the fourth set of data packets, and a means for reconstructing a sixth set of data packets from the fourth set of data packets and the fifth set of data packets, the sixth set of data packets being transmitted from the user location.

In other examples, any of the approaches and aspects above can include one or more of the following features. The method further includes receiving a third set of data packets at a second data center selected from the plurality of data centers, the second data center being different than the first data center, filtering the third set of data packets to form a fourth set of data packets, adding the indicator to one or more data packets in the fourth set of data packets, and transmitting the fourth set of data packets to the fraud detection system.

In other examples, the method further includes reconstructing data, at the fraud detection system, from the second set of data packets and the fourth set of data packets, the second set of data packets and the fourth set of data packets being transmitted from a same user location. The method further includes determining, at the fraud detection system, whether the one or more data packets with the indicator associated with the second set of data packets and the fourth set of data packets is fraudulent based on one or more rules and determining, at the fraud detection system, whether the data is fraudulent based on the one or more rules.

In some examples, the first data center is selected from the plurality of data centers according to available capabilities of the data centers, condition of one or more networks associated with the data centers, a quality of service indicator on the data packets, application availability, number of connections to each data center, and/or a pre-defined routing instruction.

In other examples, the first set of data packets and the second set of data packets are the same. The filtering includes filtering by an internet protocol (IP) address, a protocol, a data type, a parameter, content, a content-type, a uniform resource locator (URL) path, an IP range, a cookie, form data, an encryption key, a transaction identifier, and/or hypertext transport protocol (HTTP) header.

In some examples, the filtering including filtering based on whether the one or more data packets in the first set of data packets include information utilized by the fraud detection system to determine whether the one or more data packets in the first set of data packets is fraudulent based on one or more rules.

In other examples, the adding the indicator includes adding the indicator based on one or more rules, and/or one or more pre-defined transactions. The one or more rules utilize global address lookup, network address, network information, routing information, time, date, device cookies, and/or device fingerprint. The one or more pre-defined transactions include fraudulent activity history, and/or fraud patterns.

In some examples, the system further includes a second data center. The second data center is selected from a plurality of data centers and different from the first data center. The second data center is configured to receive a third set of data packets, filter the third set of data packets to form a fourth set of data packets, add the indicator to one or more data packets in the fourth set of data packets, and transmit the fourth set of data packets to the fraud detection system.

In other examples, the fraud detection system is further configured to reconstruct data from the second set of data packets and the fourth set of data packets, the second set of data packets and the fourth set of data packets being transmitted from a same user location.

In some examples, the fraud detection system is further configured to determine whether the one or more data packets with the indicator associated with the second set of data packets and the fourth set of data packets is fraudulent based on one or more rules and determine whether the data is fraudulent based on the one or more rules.

In other examples, a data collection module is configured to receive the first set of data packets. A filter module is configured to filter the first set of data packets to form the second set of data packets. A indicator module is configured to add the indicator to the one or more data packets in the second set of data packets.

In some examples, the method further includes receiving the third set of data packets and the sixth set of data packets at a fraud detection system and reconstructing a seventh set of data packets from the third set of data packets and the sixth set of data packets, the seventh set of data packets being transmitted from the same user location.

In other examples, the method further includes determining whether the seventh set of data packets is fraudulent based on one or more rules.

In some examples, the first data center is selected from the plurality of data centers according to available capabilities of the data centers, condition of one or more networks associated with the data centers, a quality of service indicator on the data packets, application availability, number of connections to each data center, and/or a pre-defined routing instruction.

In other examples, the second set of data packets being related to the first set of data packets based on a user, the user location, and/or a cookie. The searching the first data center for the second set of data packets further includes searching data packets received by the first data center, data packets transmitted by the first data center, or both.

In some examples, the searching the first data center for the second set of data packets further comprises analyzing one or more cookies associated with the first set of data packets, the second set of data packets, or both.

In other examples, a fraud detection system configured to receive the third set of data packets and the sixth set of data packets and reconstruct a seventh set of data packets from the third set of data packets and the sixth set of data packets, the seventh set of data packets being transmitted from the same user location.

In some examples, the fraud detection system is further configured to determine whether the seventh set of data packets is fraudulent based on one or more rules. A first data collection module is configured to receive the first set of data packets.

In other examples, the first data collection module is further configured to search the first data center for the second set of data packets related to the first set of data packets. A first reconstruction module is configured to reconstruct the third set of data packets from the first set of data packets and the second set of data packets.

In some examples, a second data collection module is configured receive the fourth set of data packets. The second data collection module is further configured to search the second data center for the fifth set of data packets related to the fourth set of data packets. A second reconstruction module is configured to reconstruct the sixth set of data packets from the fourth set of data packets and the fifth set of data packets.

An advantage is that indicator flags are associated with data packets from a plurality of sources (e.g., data centers, users, networks) which increases the detection rate of fraudulent activity by focusing the fraud detection processing. Another advantage is that the parsing and/or indicating of fraudulent activity decreases the detection time of fraudulent activity which thereby decreases the money spent on correcting fraud.

An additional advantage is that the system allows for the proactive identification of potentially fraudulent activity through the use of indicators on the data packets which reduces the time to identify and stop fraudulent activity. Another advantage is that the collected data can be summarized into a useful data set that has been filtered and flagged for the more efficient detection of fraudulent activity.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a functional block diagram of an exemplary system depicting two data centers.

FIG. 2 is a functional block diagram of an exemplary system depicting a fraud detection system.

FIG. 3A is an exemplary screen shot of a login module.

FIG. 3B is an exemplary diagram of information sent to a login module.

FIG. 3C is an exemplary screen shot of a search module.

FIG. 3D is an exemplary diagram of information transmitted to a search module.

FIG. 3E is an exemplary diagram of information received from a search module.

FIG. 3F is an exemplary screen shot of information received from a search module.

FIG. 3G is an exemplary diagram of information transmitted to a transaction module.

FIG. 4 is a flowchart depicting the filtering of data through an exemplary system.

FIG. 5 is a flowchart depicting the discarding of data through an exemplary system.

### DETAILED DESCRIPTION

As a general overview of the Applicants' technology, data packets (e.g., hypertext transfer protocol (HTTP) hits, HTTP transactions) associated with user requests are distributed among a plurality of data centers for processing. The data packets are captured at the data centers for fraud detection.

The captured data packets are preprocessed at the data center. The preprocessing includes disregarding data packets that are not applicable to fraud detection (e.g., no cookie information in data packet which means that a customer cannot be associated with the data packet, request for help information). The preprocessing includes indicating which data packets are applicable to fraud detection (e.g., flagging the data packets). The indicating of the applicable data packets includes parsing the data packets using particular rules (e.g., logic optimized to assist investigation, pre-defined transactions) optimized for fraud detection.

Since the data packets are distributed among a plurality of data centers for processing, the data packets at each data center only represent part of the data packets associated with a user. The data packets are processed at each data center to reconstruct part of the data associated with a user. The processing of the data packets includes reconstructing the data packets based on customer information, network information, cookie information, and/or information associated with the data packet. The reconstructed data packets are transmitted to a central processing center (e.g., central data center). The central processing center receives reconstructed data packets from the plurality of data centers and reconstructs the reconstructed data packets into data associated with a user.

In some examples, data collected from the network is parsed to disregard data that is not applicable for fraud detection. In other examples, data collected from the network is flagged for identification and to indicate potential fraudulent activity. In some examples, data packets collected at a data center are processed at the data center to reconstruct a partial or complete set of the data sent to and from the user. The partial reconstruction of data is then transmitted to a processing center (e.g., central data center) for reconstruction with partially reconstructed data from a plurality of data centers to form the data associated with a user.

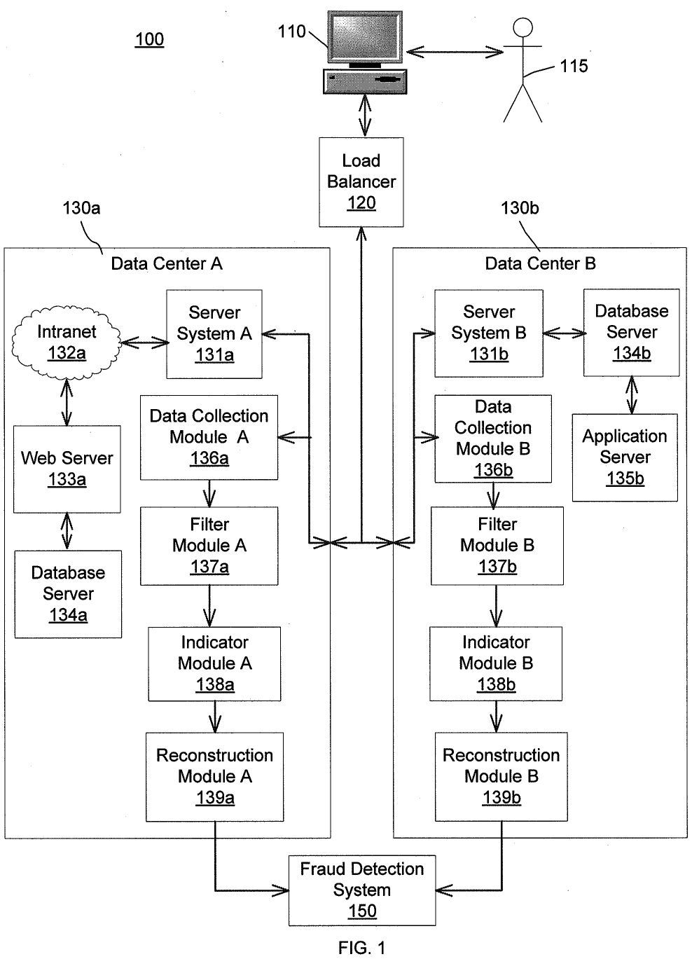

FIG. 1 is a functional block diagram of an exemplary system 100 depicting two data centers 130a and 130b (generally 130). The user 115 utilizes a transmitting device 110 (e.g., computer, cell phone) to communicate over one or more networks (not shown) to a load balancer 120. The transmitting device 110 can communicate utilizing data. The data can include one or more data packets.

The load balancer 120 transmits the data packets to the different data centers 130 based on load balancing techniques. The data packet is transmitted from the load balancer 120 to a data center 130a or 130b selected from the plurality of data centers.

The flow and interaction of data packets in the data centers 130 are described below. The data packets in the data center 130a and 130b are transmitted to the server systems 131a and 131b and the data collection modules 136a and 136b, respectively. For example, a data packet is transmitted from the user's transmitting device 110 to the load balancer 120. The data packet is transmitted to data center A 130a from the load balancer 120. The data packet is transmitted in the data center A 130a to the server system A 131a and to the data collection module A 136a.

The data collection modules 136a and 136b (generally 136) can capture the data packets transmitted by the server systems 131a and 131b, respectively, back to the user. For example, the user 115 using a transmitting device 110 transmits a data packet requesting information. The data packet is routed through the load balancer 120 to data center B 130b. The data packet is transmitted to the server system B 131b and the data collection module B 136b. The server system B 131b processes the data packet and responds to the user's request by transmitting a data packet response. The data packet response is captured by the data collection system B 136b.

The data packet and/or data packet response are transmitted from the data collection systems 136 to the filter modules 137a and 137b (generally 137), respectively. The filter modules 137 filter data packets that are not utilized for fraud detection. The filter modules 137 transmit the data packets that are utilized for fraud detection to the indicator modules 138a and 138b (generally 138). The indicator modules 138 add an indicator (e.g., flag attached to data packet, flag in a database that tracks the data packets) to the data packets. The indicator is utilized by the fraud detection system 150 to indicate additional processing for the data packets.

The indicator modules 138 transmit the data packets to the reconstruction modules 139a and 139b (generally 139). The reconstruction modules 139 process the data packets to form part or all of the data from the user 115. The reconstructed data is a representation of part or all of the information transmitted over the network by the user's transmitting device 110 (e.g., the raw information that is transmitted over the network). The reconstruction modules 139 reconstruct the data packets sent through each of the data centers 130a and 130b to form reconstructed data for the data center 130a or 130b.

The reconstructed data (e.g., one data packet, ten data packets associated with a user 115, one hundred data packets associated with a user 115) is transmitted to the fraud detection system 150. The fraud detection system 150 processes the data packets to determine if the data packets represent fraudulent activity.

The processing by the server systems 131 includes the communication of the data packets with other servers and/or modules (e.g., web server, database server, application server, authentication module, encryption module).

In reference to data center A 130a, server system 131a communicates data packets to an intranet 132a which transmits data packets to a web server 133a. The web server 133a processes the data packets to determine if the web server 133a needs to respond to the data packets and/or if the web server 133a needs to access information from the database server 134a. If the web server 133a needs information from the database server 134a to respond to the data packet (e.g., a search submission to a search module that is part of the web server 133a). The web server 133a queries the database server 134a and the database server 134a responds to the query (e.g., the information that is requested from the search). The web server 133a processes the information returned from the query and transmits a web page with the requested information back to the transmitting device 110 of the user 115.

In reference to data center B 130b, server system 131b communicates data packets to a database server 134b which accesses information that the server system B 131b needs to process data packets. The database server 134b communicates with an application server 135b to process a request associated with data packets.

In some examples, the reconstruction modules 139 analyze the data packets to determine data packet information. The data packet information includes, for example, a destination parameter, and/or an origination parameter. The data packet parameters can be used by the reconstruction module 139 to match data packets together to form the data of the user 115. The data packet parameters includes, for example, a user address, an operating system (OS) fingerprint, a network card address, a user cookie, form data, an encryption key, and/or a transaction identifier.

In other examples, the user address includes, for example, the address of the user 115 at the transmitting device 110 transmitting the data packet, identifying information of the user's transmitting device 110, or other identifying information that is associated with the user 115. The OS fingerprint includes, for example, the formatting of the data that indicates the OS that transmits the data packet, identifying information in the data packet from the OS, or other identifying information that is associated with the OS. The network card address includes, for example, the address of the network card in the user's transmitting device 110 or other identifying information of the transmitting device that is associated with the transmitting device 110.

In other examples, the user cookie includes information stored on the user's transmitting device 110 (e.g., information stored in a web browser on the user's transmitting device 110) and/or other identifying information that is stored on the user's transmitting device 110. The form data includes, for example, information in the data packets associated with the user 112 (e.g., information in the data packet such as UserID=GeorgeSmith) and/or other identifying information in the data packets.

In some examples, the data packet parameter includes a network address. The network address includes, for example, the address of the transmitting device 110 transmitting the data packet, the address of the network address translation device (e.g., firewall) that transmits the data packet, or other network devices that transmit data packets.

In some examples, the reconstruction modules 139 process the data packets to determine if the data packets match a request from the server systems 131. For example, the server system A 131a transmits a request for information (i.e., a data packet requesting information from a user 115) to a user 115 (e.g., login information—userid and password). The user 115 responds through the transmitting device 110 by transmitting a data packet (e.g., userid and password). The reconstruction module A 139a matches the request for information from the server module A 131a to the data packet from the user 115 (e.g., the request for login information to the login information). The matching of the request for information from the server system A 131a to the data packet from the user 115 is used by the reconstruction module A 139a to match data packets together.

In other examples, the reconstruction modules 139 process the data packets. The processing of the data packets includes filtering, decrypting, and/or encrypting (e.g., Radware® SSL Decryption available from Radware Ltd.).

In some examples, the reconstruction modules 139 searches for other data packets related to the data packets (e.g., same user). For example, if the user George transmits a request to purchase ten shares of ABC's stock and the reconstruction module 139 receives the request data packet, then the reconstruction module 139 searches for any other data packet to and/or from George. When the reconstruction module 139 receives all of the related data packets, the reconstruction module 139 reconstructs the data at that data center 130 and transmits the reconstructed data to the fraud detection system 150.

In other examples, the searching for other data packets by the data collection modules 136 includes temporarily storing data packets for a set time and/or until a set number of related data packets have been received. In some examples, the searching for other data packets by the reconstruction modules 136 includes querying other modules and/or servers in the data center 130 for data packets related to the data packet. For example, the reconstruction module A 139a queries the server system A 131a and requests all data packets related to the data packet. The relationship between data packets can be, for example, the same user, users associated with each other, the same IP address, IP addresses associated with each other, and/or any other type of relationship.

In some examples, the load balancing techniques include selecting a data center (e.g., 130a) from a plurality of data centers 130 according to the available capabilities of the data centers (e.g., processor availability, disk capacity), the conditions of the network (e.g., packet trip time, packet losses, availability), a quality of service indicators on the data packet, application availability, number of connections to each data center 130, and/or a pre-defined routing instruction.

In other examples, the system 100 receives data packets from other systems. The other systems include one or more network systems that each include one or more transmitting devices 110. The other systems can transmit data to the load balancer 120 for transmission to the data centers 130 for processing.

In some examples, the processing of the data packets by the server systems 131 can occur at or near the same time and separately from the data collection modules 136 collecting the data and the processing described herein. For example, the data packets are transmitted through the server system A 131a for processing at or near the same time as the data collection module A 136a transmits the data packets to the filter module A 137a, the indicator module A 138a, and the reconstruction module A 139a processes the data packet.

In some examples, the filter module 137 filters based on whether the data packet includes information utilized by the fraud detection system 150 to determine if the data packet is fraudulent. The fraud detection system 150 can determine, for example, if the data packet is fraudulent based on one or more rules.

In other examples, the filter module 137 filters by an internet protocol (IP) address, a protocol (e.g., header in a protocol, protocol type), a data type (e.g., css file, jpg file, gif file), a parameter (e.g., browser characteristic, referrer site), content, a content-type, a uniform resource locator (URL) path (e.g., generic page decorations, generic information), an IP range, a cookie, form data, an encryption key, a transaction identifier, and/or a hypertext transport protocol (HTTP) header.

In some examples, the indicator modules 138 adds the indicator based on one or more rules, and/or one or more pre-defined transactions. The one or more rules utilize, for example, global address lookup, network address, network information, routing information, time, date, device cookies, and/or device fingerprint. The one or more pre-defined transactions include, for example, fraudulent activity history and/or fraud patterns (e.g., authentication attempts, unsuccessful logins, blocking of PIN, resetting of PIN). The fraud patterns can include, for example, a contact information modification (e.g., address change, phone number change, email change), an account information modification (e.g., beneficiary change, payment change, enrollment to services), a transaction (e.g., cash transfers, bill payments, trading) and/or a new account (e.g., new account setup for existing customer).

In other examples, the transmission of the data packet in the data centers 130 to the server systems 131 and to the data collection modules 136 can occur simultaneously and independently from each other using for example, a network device. The network device includes, for example, a network router, a network firewall, a network hub, a network switch, a computer, and/or other network devices (e.g., Gigamon GigaVUE-MP available from Gigamon Systems LLC).

The server systems 131 each can include one or more servers. The server includes, for example, a web server (e.g., 133a), an application server (e.g., 135b) (e.g., Oracle® Application Server 10g available from Oracle Corporation), a database server (e.g., 134a, 134b) (e.g., Oracle® Database 10g available from Oracle Corporation), a communication server, a fax server, a file server, a game server, an authentication server (e.g., RSA® Authentication Manager available from RSA Security Inc.), a desktop computer, a central ad server, a file transport protocol server, an image server, a mail server, a news server, a proxy server, a printer server, a sound server, a streaming media server, a terminal server, a firewall, a network router, a network hub, a network (e.g., an intranet 132a) and/or a network switch.

In some examples, the data collection modules 136 include one or more computing devices which can be, for example, a computer, a laptop computer, a network router, a network switch, and/or a network hub (e.g., Radware® AS4 available from Radware Ltd., Covelight Inflight™ 5000 available from Covelight System, Inc., Gigamon GigaVUE-MP available from Gigamon Systems LLC).

The data collection modules 136 can capture, for example, the data packets from the network without interfering with the transmission of the data to the rest of the network. For example, the data collection modules 136 receive data packets transmitted to the data centers 130 from the load balancer 120 while at the same time the data packets are received by the server systems 131, creating a parallel path for receiving the data packets.

Although FIG. 1 is shown with two data centers 130a and 130b, other examples include a plurality of data centers (e.g., ten, one hundred, four hundred, one thousand). Similarly, although FIG. 1 illustrates one load balancer 120, other examples include a plurality of load balancers in multiple layers. For example, a user's transmitting device 110 transmits data packets to the first load balancer 120 which is connected to a layer of load balancers (not shown). The first load balancer 120 transmits the data packet a second load balancer (not shown) selected from the layer of load balancers based on load balancing techniques and/or the geographic location of the load balancers and/or data centers. The second load balancer on the layer below the first load balancer 120 transmits the data packet to a data center (e.g., 130a) selected from the plurality of data centers.

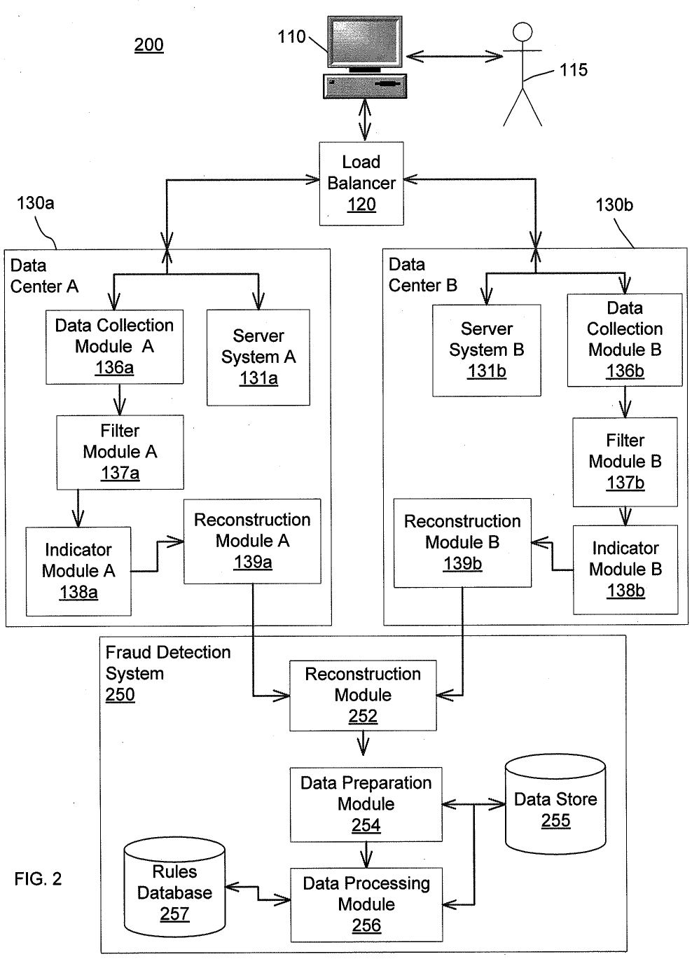

FIG. 2 is a functional block diagram of an exemplary system 200 depicting a fraud detection system 250. The user 115 utilizes a transmitting device 110 (e.g., computer, cell phone) to communicate over one or more networks (not shown) to a load balancer 120. The transmitting device 110 can communicate utilizing data. The data can include one or more data packets.

The load balancer 120 transmits the data packets to the different data centers 130 based on load balancing techniques. The data packet is transmitted from the load balancer 120 to a data center 130a or 130b selected from the plurality of data centers.

The flow and interaction of data packets in the data centers 130 are described below. The data packets in the data center 130a and 130b are transmitted to the server systems 131a and 131b and the data collection modules 136a and 136b, respectively. For example, a data packet is transmitted from the user's transmitting device 110 to the load balancer 120. The data packet is transmitted to data center A 130a from the load balancer 120. The data packet is transmitted in the data center A 130a to the server system A 131a and to the data collection module A 136a.

The data collection modules 136a and 136b (generally 136) can capture the data packets transmitted by the server systems 131a and 131b, respectively, back to the user. For example, the user 115 using a transmitting device 110 transmits a data packet requesting information. The data packet is routed through the load balancer 120 to data center B 130b. The data packet is transmitted to the server system B 131b and the data collection module B 136b. The server system B 131b processes the data packet and responds to the user's request by transmitting a data packet response. The data packet response is captured by the data collection system B 136b.

The data packet and/or data packet response are transmitted from the data collection systems 136 to the filter modules 137a and 137b (generally 137), respectively. The filter modules 137 filter data packets that are not utilized for fraud detection. The filter modules 137 transmit the data packets that are utilized for fraud detection to the indicator modules 138a and 138b (generally 138). The indicator modules 138 add an indicator (e.g., flag attached to data packet, flag in a database that tracks the data packets, header added to the data packet, HTTP header added to the HTTP transaction) to the data packets. The indicator is utilized by the fraud detection system 150 to indicate additional processing for the data packets.

The indicator modules 138 transmit the data packets to the reconstruction modules 139a and 139b (generally 139). The reconstruction modules 139 process the data packets to form part or all of the data from the user 115. The reconstructed data is a representation of part or all of the information transmitted over the network by the user's transmitting device 110 (e.g., the raw information that is transmitted over the network). The reconstruction modules 139 reconstruct the data packets sent through each of the data centers 130a and 130b to form reconstructed data for the data center 130a or 130b.

The reconstructed data (e.g., one data packet, ten data packets associated with a user 115, one hundred data packets associated with a user 115) is transmitted to the fraud detection system 250.

In general, the fraud detection system 250 processes the data packets to determine if the data packets represent fraudulent activity. The determination of whether the data packets represent fraudulent activity can utilize one or more rules and/or patterns. The fraud detection system 250 includes a reconstruction module 252, a data preparation module 254, a data processing module 254, a data store 255, and a rules database 257. The reconstruction module 252 receives the partially and/or fully reconstructed data from the data centers 130. The reconstruction module 252 reconstructs the data from the reconstructed data from the data centers 130. An advantage of reconstructing the data at each data center is that the processing time of data can be decreased at the fraud detection system.

The reconstructed data is communicated to the data preparation module 254. The data preparation module 254 processes the reconstructed data. The processing by the data preparation modules 254 includes storing part or all of the reconstructed data in the data store 255, modifying the reconstructed data based on one or more predetermined data templates, and/or extracting information from the reconstructed data.

The data processing module 256 processes the reconstructed data, information in the template, and/or the extracted information to determine if the user's activity is fraudulent activity. The data processing module 256 can access the data store 255 to retrieve, store, and/or update information associated with the reconstructed data and/or the reconstructed data. The data processing module 256 utilizes rules stored in the rules database 257 to determine if the activity is fraudulent activity. In some examples, the partially reconstructed data includes one or more data packets (e.g., one data packet, twenty data packets, four hundred data packets).

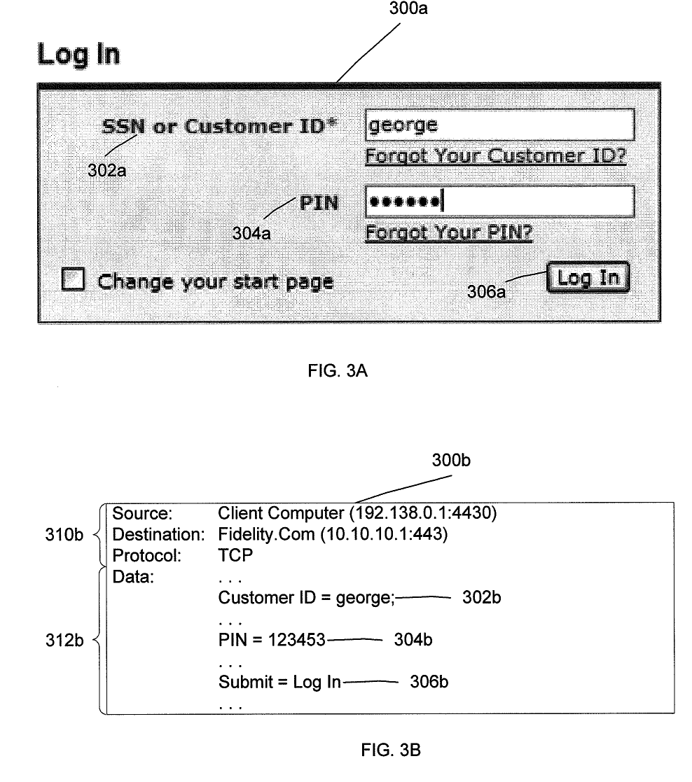

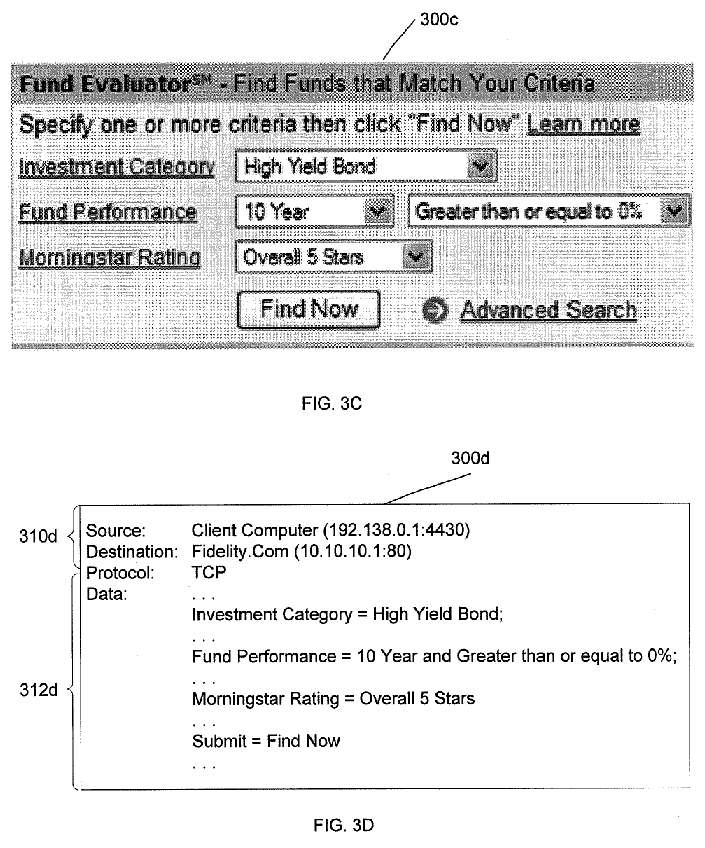

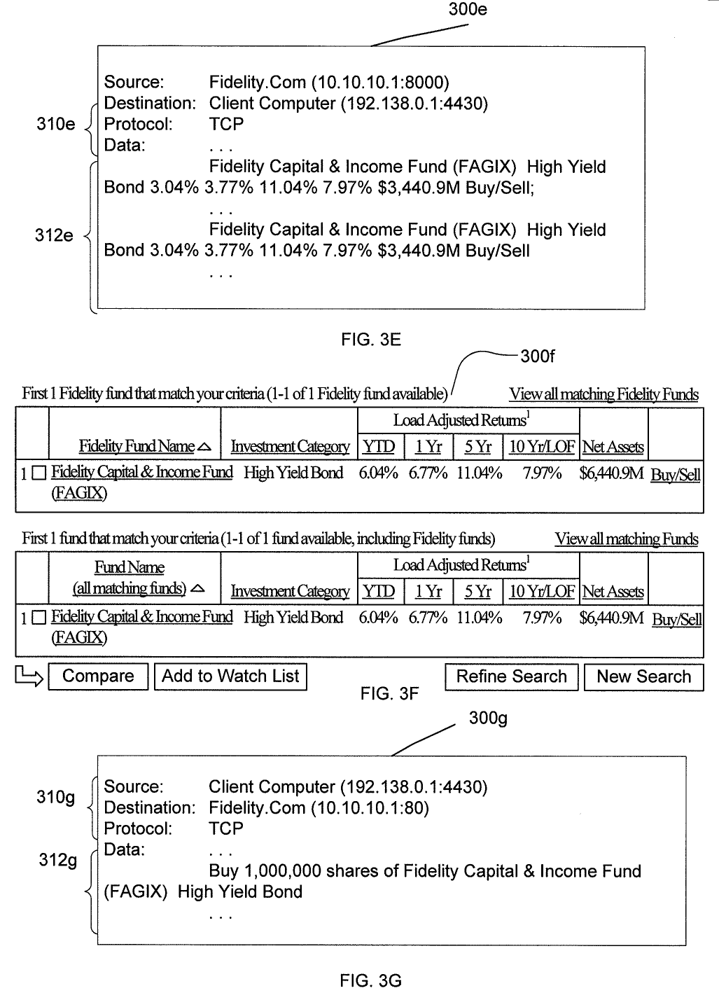

FIG. 3A is an exemplary screen shot 300a generated by a login module. The screen shot 300a shows the login screen generated by the login module that is included in the network associated with the load balancer 120 of FIG. 1. The login screen includes a customer identification field 302a, a pin field 304a, and an information submission button 306a. The fields 302a, 304a, and 306a are part or all of the information in the user request.

FIG. 3B is a diagram 300b of information sent from the transmitting device 110 of FIG. 1 to the login module that includes the information in FIG. 3A. The diagram 300b is part or all of the data packet. The information parameters 310b define how the information is routed and/or processed. The information parameters 310b include the source of the information, the destination of the information, routing information, the protocol for the information, and/or other types of transmitting parameters. The information data 312b includes the content information. The information data 312b includes formatting information, content information, transaction information, and/or other types of content information. The transaction information can comprise the customer id 302b which corresponds with the customer id field of the login screen 302a. The transaction information can comprise the pin 304b which corresponds with the pin field of the login screen 304a. The transaction information can comprise the login in 306b command information which corresponds with the log in submission button 306a. The fields 302b, 304b, and 306b are part or all of the information in the data packet.

FIG. 3C is a screen shot 300c generated by a search module in the server system 122a or 122b of FIG. 3. The fields in the screen shot 300c can comprise part or all of the information in the user request.

FIG. 3D is a diagram 300d of information transmitted from the transmitting device 110 of FIG. 1 to the search module in the server system 131a or 131b that includes the information in FIG. 3C. The diagram 300d is part or all of the data packet. The information parameters 310d define how the information is routed and processed. The information data 312d includes the content information.

FIG. 3E is a diagram 300e of information received from the search module in the server system 131a or 131b of FIG. 1. The diagram 300e is part or all of the data packet. The information parameters 310e define how the information is routed and processed. The information data 312e includes the content information.

FIG. 3F is a screen shot 300f of information generated by the search module in the server system 131a or 131b of FIG. 1. The screen shot 300f shows the information received from a search module. The information shown in the screen shot 300f corresponds with the information 312e in the diagram of FIG. 3E.

FIG. 3G is a diagram 300g of information transmitted to a transaction module in the server system 131a or 131b of FIG. 1. The diagram 300g is part or all of the data packet. The information parameters 310g define how the information is routed and processed. The information data 312g includes the content information.

The diagrams of information 300b, 300d, 300e, and 300g represent data packets collected at the data collection system 131a or 131b of FIG. 1. The reconstructed data is a combination of all of the data packets collected at the data collection modules 136a and 136b. The reconstructed data is the information that is transmitted from the transmitting device 110 and from the server systems 131a and 131b (e.g., all of the raw packets that are transmitted over the system 100).

In some examples, the diagrams of information 300b, 300d, 300e, and 300g are encrypted. The diagrams of information 300b, 300d, 300e, and 300g can be, for example, temporarily decrypted for reconstruction. The diagrams of information 300b, 300d, 300e, and 300g can be, for example, decrypted for reconstruction and stored in a separately encrypted database for data security.

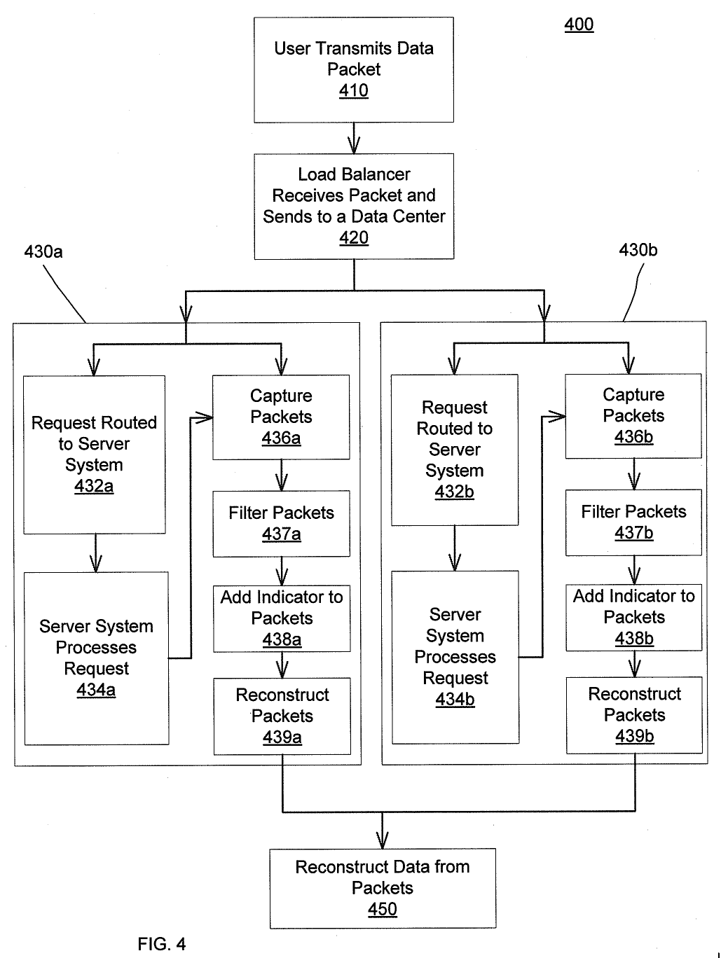

FIG. 4 is a flowchart 400 depicting the filtering of data through an exemplary system 200 of FIG. 2. The user 115 utilizing a transmitting device 110 transmits (410) a data packet to a load balancer 120. The load balancer 120 receives (420) the data packet and sends (420) the data packet to a data center (e.g., data center A 130a) based on load balancing techniques.

If the load balancer 120 sends (420) the data packet to data center A 130a (430a), then the data packet as a request is routed (432a) to the server system A 131a. The server system A 131a processes (434a) the request. The data collection module A 136a captures (436a) the response, if any, from the server system A 131a and the data packet sent (420a) from the load balancer 120. The packets captured by the data collection module A 136a are communicated to a filter module A 137a. The filter module A 137a filters (437a) the data packets. The filtered data packets are communicated to the indicator module A 138a. The indicator module A 138a adds (438a) one or more indicators to the filtered packets. The packets are communicated to the reconstruction module A 139a. The reconstruction module A 139a reconstructs (439a) data packets from a user 115. The reconstructed data is communicated to the reconstruction module 252.

If the load balancer 120 sends (420) the data packet to data center B 130b (430b), then the data packet as a request is routed (432b) to the server system B 131b. The server system B 131b processes (434b) the request. The data collection module B 136b captures (436b) the response, if any, from the server system B 131b and the data packet sent (420b) from the load balancer 120. The packets captured by the data collection module B 136b are communicated to a filter module B 137b. The filter module B 137b filters (437b) the data packets. The filtered data packets are communicated to the indicator module B 138b. The indicator module B 138b adds (438b) one or more indicators to the filtered packets. The packets are communicated to the reconstruction module B 139b. The reconstruction module B 139b reconstructs (439b) data packets from a user 115. The reconstructed data is communicated to the reconstruction module 252.

The reconstruction module 252 reconstructs (450) the data from a user 115. The reconstruction (450) can be based, for example, on information associated with the data packets, the reconstructed data from each of the data centers 130a and 130b, and/or information associated with the user 115.

For example, the data packet associated with the login screen 300a of FIG. 3A and the diagram 300b of information is transmitted (410) from the user 115 of FIG. 2 utilizing the transmitting device 110. The data packet is transmitted through the internet (not shown) to the load balancer 120. The load balancer 120 receives (420) the data packet and sends (420) the data packet with the login information (in this example, the customer ID 302b and the PIN 304b) to a data center. The load balancer 120 determines that data center A 130a can process the data packet (in this example, the request to login) based on its higher processing availability then data center B 130b. The load balancer 120 sends (420) the data packet to data center A 130a (430a). The data collection module A 136a captures (436a) the data packet.

The captured data packet (in this example, the diagram of information 300b with the login information 312b) is communicated to the filter module A 137a. The filter module A 137a filters (437a) the data packet to determine if the data packet can be utilized for fraud detection. If the data packet cannot be utilized for fraud detection, then the data packet is discarded. If the data packet can be utilized for fraud detection, then the data packet is communicated to the indicator module A 138a (in this example, the data packet has the user's login information and can be utilized for fraud detection). An advantage is that the determination of fraudulent activity is faster and requires less processing because the amount of information to process is reduced.

The indicator module A 138a adds (438a) an indicator to the data packet, if the data packet should receive extra processing by the fraud detection system 250. The source of the data packet (as illustrated in the header information 310b) is 192.138.0.1 which is flagged by the indicator module A 138a as a source of potentially fraudulent activity. Accordingly, the indicator module A 138a adds an indicator to the data packet (in this example, the diagram of information 300b) for the fraud detection system 250 to provide an extra level of review on the transaction of the user 115. The data packet is communicated to the reconstruction module A 139a. An advantage is that indicators of fraudulent activity can be quickly spotted by the fraud detection system 250 thereby decreasing the time and processing to catch and stop fraudulent activity.

The request (in this example, the diagram of information 300b) is routed (432a) to the server system A 131a. The server system A 131a processes (434a) the request and responds with an authentication into the system (not shown). The response is captured (436a) by the data collection module A 136a. The data collection module A 136a communicates the response to the filter module A 137a which filters (437a) the response to determine if the response can be utilized for fraud detection (in this example, the response has the system's response to a user's login request and can be utilized by the fraud detection system 250). The response is communicated to the indicator module A 138a. The indicator module A 138a adds (438a) an indicator to the response since the destination address of the response is to the user's transmitting device network address which is flagged as a source of potentially fraudulent activity. In this example, the indicator is added as a header field into the response data packet (e.g., Flag: Possible Fraudulent Activity, Flag: Process Level 2). The response is communicated to the reconstruction module A 139a.

The reconstruction module A 139a received the request (in this example, the diagram 300b of information) and the response from the server system A 131a. The reconstruction module A 139a processes the request and the response and determines that the data packets for each are associated with the same user (in this example, user 115). The reconstruction module A 139a reconstructs (439a) the request and response together into the data from the user 115. The reconstructed data (in this example, the request and response) is communicated to the fraud detection system 250 which reconstructs (450) the data associated with the user 115 from reconstructed data received from all of the data centers (in this example, data center A 130a and data center B 130b).

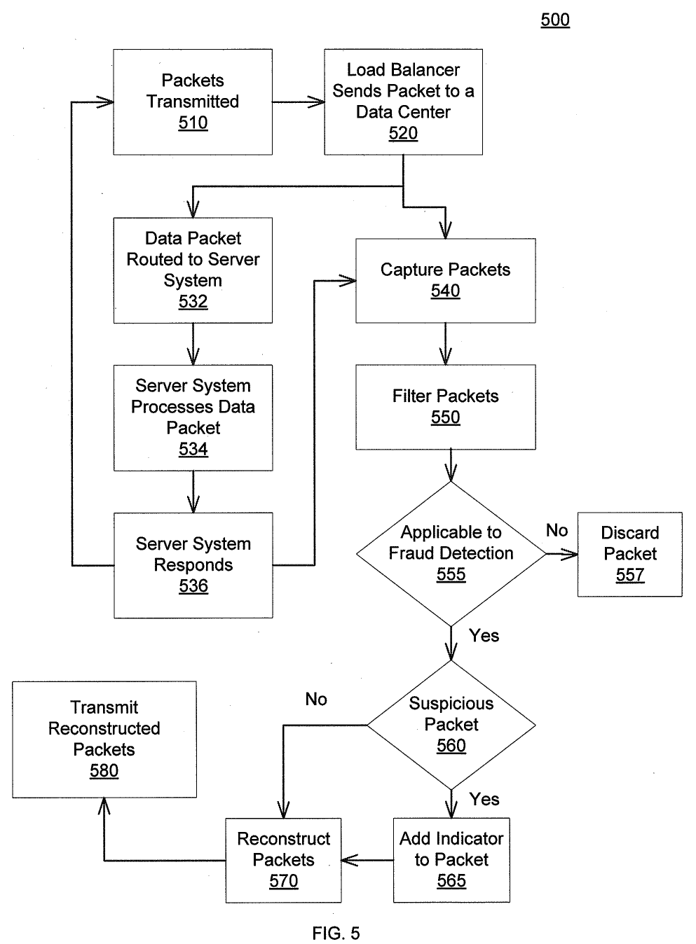

FIG. 5 is a flowchart 500 depicting the discarding of data through an exemplary system 200 of FIG. 2. The data packets are transmitted (510) from a user 115 utilizing a transmitting device 110. Although the flowchart 500 can reference any data center selected from a plurality of data centers, the flowchart 500 will utilize data center A 130a for the description of the flowchart 500. The load balancer 120 receives the data packets and sends (520) each data packet to a data center 130a selected from a plurality of data centers based on load balancing techniques. The data packet in the data center 130a is routed (532) to the server system 131a and is captured (540) by the data collection module 136a.

The data packet is filtered (550) by the filter module 137a. If the data packet is applicable (555) to fraud detection, then the data packet is communicated to the indicator module 138a. If the data packet is not applicable (555) to fraud detection, then the data packet is discarded (557). The indicator module 138a determines (560) if the data packet is a suspicious packet (e.g., matches a rule and/or pattern for fraudulent activity, originates from an IP range that sends fraudulent packets). If the data packet is a suspicious packet, then the indicator module 138a adds (565) an indicator to the data packet. If the data packet is not a suspicious packet, then the indicator module 138a does not add an indicator to the data packet. The data packet is communicated to the reconstruction module 139a which reconstructs (570) the data packets into reconstructed data.

The server system 131a processes (534) the data packet and responds (536) to the data packet. The data collection module A 136a captures (540) the response from the server system 131a. The response is filtered (550) by the filter module 137a. If the response is applicable (555) to fraud detection, then the response is communicated to the indicator module 138a. If the response is not applicable (555) to fraud detection, then the response is discarded (557). The indicator module 138a determines (560) if the response is a suspicious packet. If the response is a suspicious packet, then the indicator module 138a adds (565) an indicator to the response. If the response is not a suspicious packet, then the indicator module 138a does not add an indicator to the response. The response is communicated to the reconstruction module 139a which reconstructs (570) the response (i.e., the data packet) into reconstructed data.

The reconstruction module 139a reconstructs (570) the data from the user 115 from the request and response data packets. The reconstructed data is transmitted (580) to the fraud detection system 250. In some examples, the server system 131a does not respond (536) to the data packet, because a response is not needed.

Although the flowchart 500 illustrates the filtering (550), indicating (565), and the reconstructing (570) occurring in series, the filtering (550), indicating (565), and the reconstructing (570) can occur in any order and/or separately from each other. For example, a data packet could be reconstructed (570) but not filtered (550) and indicated (565). Conversely, for example, a data packet could be filtered (550) and indicated (565) but not reconstructed (570).

For example, the data packet associated with the screen shot 300c of FIG. 3C of a search module (not shown) and the diagram 300d of information of FIG. 3D is transmitted (510) from the user 115 of FIG. 2 utilizing the transmitting device 110. The load balancer 120 sends (520) the data packet to data center B 130b based on the memory utilization of data centers A 130a and B 130b (in this example, data center A 130a has 60% memory utilization and data center B 130b has 55% memory utilization). The data packet is routed (532) to the server system B 131b. The server system B 131b processes (534) the data packet and responds (536) to the request for search results with the search results as illustrated by the diagram 300e of information in FIG. 3E and the screen shot 300f in FIG. 3F.

The request and response data packets are captured (540) by the data collection module B 136b. Each data packet (i.e., request and response) is filtered (550) by the filter module B 137b. The request data packet is not applicable (555) to fraud detection and is discarded (557) (in this example, the cookie information is not communicated so the filter module 137b determines that the analysis of the packet is not worth the resources of analysis). The response data packet is not applicable (555) to fraud detection and is discarded (557) (in this example, the response includes publicly available stock information so the filter module 137b determines that the analysis of the packet is not worth the resources of analysis).

The diagram 300g of information of FIG. 3G illustrates an order by the user 115 for the purchase of 1,000,000 shares. The data packet illustrated by the diagram 300g of information is transmitted (510) to the load balancer 120 from the user's transmitting device 110 (e.g., cell phone, laptop). The load balancer 120 sends (520) the data packet to data center A 130a based on the network utilization of the network A (not shown) between the load balancer 120 and the data center A 130a (in this example, network A was at 51% utilization and network B (not shown) between the load balancer 120 and the data center B 130b was at 65% utilization).

The data packet is captured (540) by the data collection module A 136a and routed (532) to the server system A 131. The server system A 131 processes (534) the data packet by purchasing 1,000,000 shares of Fidelity Capital & Income Fund (FAGIX) High Yield Bonds for the user 115 (in this example, Customer ID=george). The server system A 131 responds (536) to the request with a buy acknowledgement (not shown). The buy acknowledgement is captured (540) by the data collection module A 136a. The data collection module A 136a communicates the buy acknowledgement to the filter module A 137a which filters (550) the buy acknowledgement. The filter module A 137a determines that the buy acknowledgement is not applicable (555) to fraud detection and discards (557) the data packet. In this example, the buy acknowledgement is not applicable to fraud detection because it is a data packet that includes acknowledgement information regarding a purchase which the fraud detection system 250 has determined is not applicable to fraud detection.

The data packet is communicated to the filter module A 137a. The filter module A 137a filters (550) the data packets and determines that the data packet is applicable (555) to fraud detection. The data packet is communicated to the indicator module A 138a. The indicator module A 138a determines (560) whether the data packet is a suspicious packet. The indicator module A 138a determines (560) that the data packet is a suspicious packet since it is for the purchase of 1,000,000 shares. The indicator module A 138a adds (565) an indicator to the packet to flag the data packet for further processing by the fraud detection system 250. The data packet is communicated to the reconstruction module A 139a which reconstructs (570) the data packet. However, since the reconstruction module A 139a does not have any other data packets from the user 115 at this time, then the reconstructed data only includes the data packet as illustrated by the diagram 300g of information. The reconstructed data is transmitted (580) to the fraud detection system 250.

In some examples, the data packet is any type of packet communicated over a network (e.g., TCP data packet, IP data packet, HTTP data packet, GSM data packet). The data packet can be, for example, a HTTP transaction and the indicator can be inserted into the HTTP code of the HTTP transaction.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device and/or in a propagated signal, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (RAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The transmitting device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for preprocessing and reconstructing data on a network, the method comprising:
receiving a first set of data packets at a first data center selected from a plurality of data centers;
searching the first data center for a second set of data packets related to the first set of data packets;
reconstructing a third set of data packets from the first set of data packets and the second set of data packets, the third set of data packets being transmitted from a user location;
receiving a fourth set of data packets at a second data center selected from a plurality of data centers, the second data center being different from the first data center;
searching the second data center for a fifth set of data packets related to the fourth set of data packets; and
reconstructing a sixth set of data packets from the fourth set of data packets and the fifth set of data packets, the sixth set of data packets being transmitted from the user location.

2. The method of claim 1, further comprising:
receiving the third set of data packets and the sixth set of data packets at a fraud detection system; and
reconstructing a seventh set of data packets from the third set of data packets and the sixth set of data packets, the seventh set of data packets being transmitted from the same user location.

3. The method of claim 2, further comprising determining whether the seventh set of data packets is fraudulent based on one or more rules.

4. The method of claim 1, wherein the first data center is selected from the plurality of data centers according to available capabilities of the data centers, condition of one or more networks associated with the data centers, a quality of service indicator on the data packets, application availability, number of connections to each data center, a pre-defined routing instruction, or any combination thereof.

5. The method of claim 1, wherein the second set of data packets is related to the first set of data packets based on a user, the user location, a cookie, or any combination thereof.

6. The method of claim 1, wherein the searching the first data center for the second set of data packets further comprises searching data packets received by the first data center, data packets transmitted by the first data center, or both.

7. The method of claim 1, wherein the searching the first data center for the second set of data packets further comprises analyzing one or more cookies associated with the first set of data packets, the second set of data packets, or both.

8. A computer program product, tangibly embodied in a computing device or a removable storage device, the computer program product including instructions being operable to cause a data processing apparatus to:
receive a first set of data packets at a first data center selected from a plurality of data centers;
search the first data center for a second set of data packets related to the first set of data packets;
reconstruct a third set of data packets from the first set of data packets and the second set of data packets, the third set of data packets being transmitted from a user location;
receive a fourth set of data packets at a second data center selected from a plurality of data centers, the second data center being different from the first data center;
search the second data center for a fifth set of data packets related to the fourth set of data packets; and
reconstruct a sixth set of data packets from the fourth set of data packets and the fifth set of data packets, the sixth set of data packets being transmitted from the user location.

9. A system for preprocessing and reconstructing data on a network, the system comprising:
a first data center, selected from a plurality of data centers, configured to:
receive a first set of data packets,
search the first data center for a second set of data packets related to the first set of data packets, and
reconstruct a third set of data packets from the first set of data packets and the second set of data packets, the third set of data packets being transmitted from a user location; and
a second date center, selected from a plurality of data centers and different from the first data center, configured to:
receive a fourth set of data packets,
search the second data center for a fifth set of data packets related to the fourth set of data packets, and
reconstruct a sixth set of data packets from the fourth set of data packets and the fifth set of data packets, the sixth set of data packets being transmitted from the user location.

10. The system of claim 9, further comprising:
a fraud detection system configured to receive the third set of data packets and the sixth set of data packets and reconstruct a seventh set of data packets from the third set of data packets and the sixth set of data packets, the seventh set of data packets being transmitted from the same user location.

11. The system of claim 10, wherein the fraud detection system is further configured to determine whether the seventh set of data packets is fraudulent based on one or more rules.

12. The system of claim 9, wherein a first data collection module is configured to receive the first set of data packets.

13. The system of claim 12, wherein the first data collection module is further configured to search the first data center for the second set of data packets related to the first set of data packets.

14. The system of claim 9, wherein a first reconstruction module is configured to reconstruct the third set of data packets from the first set of data packets and the second set of data packets.

15. The system of claim 9, wherein a second data collection module is configured receive the fourth set of data packets.

16. The system of claim 15, wherein the second data collection module is further configured to search the second data center for the fifth set of data packets related to the fourth set of data packets.

17. The system of claim 9, wherein a second reconstruction module is configured to reconstruct the sixth set of data packets from the fourth set of data packets and the fifth set of data packets.

18. A system for preprocessing and reconstructing data on a network, the system comprising:
a means for receiving a first set of data packets at a first data center, selected from a plurality of data centers;
a means for searching the first data center for a second set of data packets related to the first set of data packets;
a means for reconstructing a third set of data packets from the first set of data packets and the second set of data packets, the third set of data packets being transmitted from a user location;
a means for receiving a fourth set of data packets at a second date center, selected from a plurality of data centers and different from the first data center;
a means for searching the second data center for a fifth set of data packets related to the fourth set of data packets; and
a means for reconstructing a sixth set of data packets from the fourth set of data packets and the fifth set of data packets, the sixth set of data packets being transmitted from the user location.
